(19) United States
(12) Patent Application Publication
(10) Pub. No.: US 2019/0084091 A1
(43) Pub. Date: Mar. 21, 2019

(54) Real Time Monitoring Method and Process Control for Water Jet Guided Laser System Machining

(71) Applicant: Zhaoli Hu, Greer, SC (US)

(72) Inventor: Zhaoli Hu, Greer, SC (US)

(21) Appl. No.: 15/998,241

(22) Filed: May 31, 2017

(51) Int. Cl. B23K 26/70; B23K 26/146

(52) U.S. Cl. CPC B23K 26/707; B23K 26/146

(57) ABSTRACT

Based on the mechanism of the water jet guided laser system, both shielding gas and optical to water jet coupling components have significant influence on the laminar flowing state of the water jet. By applying a camera and imaging system to monitor the laser jet and analyze the width comparing to pre-measured and stored data, we can draw a conclusion on health of optical to water jet coupling components as well as the machining progress of the laser beam. A clear system definition and procedure have been defined to understand and implement this invention.

### FIELD OF THE INVENTION

The present invention is directed to provide a real-time monitoring method for water jet guided laser machining process. More particularly, the water jet status and laser beam quality will be monitored and feedback to machine. Signal will be interpreted and used to control the machining process.

### BACKGROUND

Water jet guided laser has been used for drilling and cutting in many industrial applications, including turbine airfoil, carbon ceramic matrix (CMC), engine fuel nozzle, medical devices . . . where precise and high quality features are needed. Usually holes, slots, low kerf cut are achieved by water jet guided laser process.

The difference of water jet guided laser vs. other regular laser systems is that laser beam of water jet guided laser is not transferred in the free space. Instead, it is confined inside a stream of water jet based on total internal reflection theory.

Water jet guided laser system is based on total internal reflection to transfer laser power, in particular, the laser is composed by numerous scattered beams that confined within water jet by total internal reflection. Once total internal reflection condition is disrupted, numerous laser beams will disperse in all directions and lose it power density for machining purpose.

One requirement to have laser transferred by total internal reflection inside the water jet is to maintain a smooth interface between water and surrounding atmosphere.

The laminar flowing status of the water jet is critical to insure smooth interface between water and surrounding atmosphere. Once the laminar flowing status of the water jet is interrupted, the efficiency of total internal reflection is impacted and laser power confined inside water jet will lose significantly.

In manufacturing system, a shielding gas is purged alongside the water jet to improve the stability of laminar flow. The type of shielding gas may vary due to different applications, usually include helium, argon or mixture, but not exclude other types of shielding gas.

Once the shielding gas is stopped or disturbed, the laminar flowing state of the water jet will be negatively impacted.

For water jet guided laser system, optical to water jet coupling system includes several high worn out rate components. Once any component is damaged or degraded during operation, the laminar flowing state of the water jet will be negatively impacted.

On the other hand, many industrial process are highly automated, i.e., the machine system is running without human supervision. Therefore, machine need to make judgement by itself on:
if the laminar flowing state of water jet is acceptable;
if laser has machined through the part;

As a result, there is a great need to know the laminar flow stability of water jet and quality of laser beam confined inside water jet.

Actions will be taken automatically by machine based on signal returned from live monitoring.

### BRIEF SUMMARY OF THE INVENTION

In the practical world, when laser beam is transferred inside the water jet, there is always some percentage loss of power in the form of random scattering laser light outside of water jet. Therefore, the water jet will show as a glowing jet. In this invention, for simplicity purpose, we call this glowing water jet as “Laser Jet”. Depends on the amount of laser power scattered out of water jet, the laser jet can be very bright to camera and showing as a bright lightening bolt. But when optical filter and attenuator is added into the camera, the laser jet will show as a light column in the camera system. Once we add a bright level threshold is set up in the analysis software of the camera system, the width of the laser jet can be measured.

Current invention provide a live monitoring method that will detect the health of optical to water jet coupling components and machining status of the confined laser beam. A camera system is calibrated to check the visible width of the laser jet, which is directly related to the laminar flowing state of the water jet. The thicker is the visible laser jet under the calibrated camera system, the worse is the stability of laminar flow. By comparing the measured to stored width inside machine memory, we can diagnose the health of the optical to water jet coupling components. By comparing the measured visible width of the water jet before machining and the measured width during machining, we can detect the finishing status of the machining.

### BRIEF DESCRIPTION OF THE DRAWINGS

FIG. 1 depicts a live monitoring procedure applied to the water jet guided laser system. Laser head 1 is unit that include all optical to water jet coupling components, laser focus lens, water supply and shielding gas supply. Water jet guided laser beam 3 is coming out from laser head 1. Shielding gas 2 is also coming out from laser head and is surrounding water jet to protect the laminar flowing state of the water jet. Camera system 4 is focusing onto the water jet. Camera system 4 is connected to a digital analysis system 5. When the laser power is turned on and start to transfer inside the water jet, laser jet is shown in digital analysis system as a light column 6, and with preset threshold applied, the width of this light column is measured and recorded as laser jet width 7.

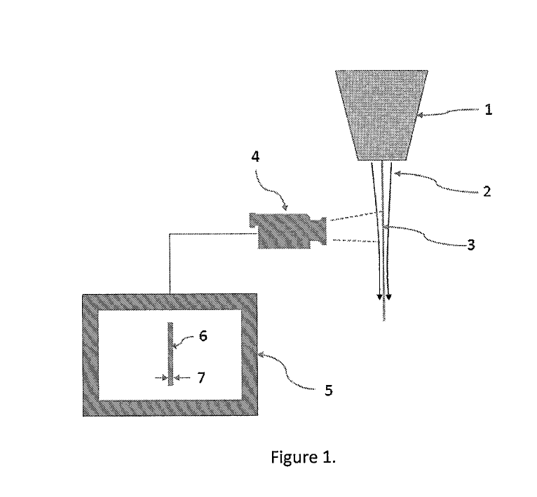

FIG. 2 indicate an on-going machining process with water jet guided laser. Because the water jet is hitting on the part surface 9, therefore there is a reflected water stream 8 from the part surface 9. The reflected water stream 8 interfere with the shielding gas and the water jet, start to generate some fluctuation 10 to the laminar flow. This fluctuation will reduce the stability of laminar flow and in turn, negatively impact the laser power transmission rate inside the water jet. More laser power will scatter out of the water jet, it will be a brighter glowing laser jet and the laser jet is then shown much thicker in the digital analysis system 5. Under the same preset bright level threshold, the light column 6 shown in the in the digital system 5 gives a bigger value of laser jet width 7.

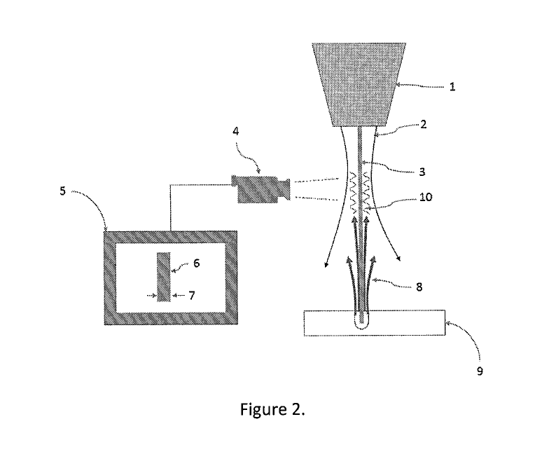

FIG. 3 shows a condition after the water jet guided laser has drilled through the part 9. Because majority of water in water jet 3 will then go through the through hole 11, the reflected water stream is significantly reduced after drill through. As the drilling process progress, the through area will get larger and larger and the reflected water stream will reduce more. Therefore, the interference to the shielding gas 2 and water jet 3 get reduced more with the progress of drilling through process. The intensity of fluctuation 10 is reduced and the stability of laminar flow is improved, and the laser power transmission rate is increased. As a result, the laser jet width 7 will get smaller in digital analysis system 5.

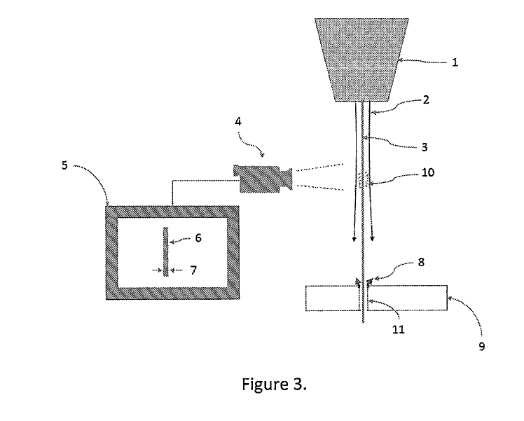

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a”, “an” and “the” are intended to include the plural forms as well as the singular forms, unless the context clearly indicates otherwise. It will be further understood that the terms “comprises” and/or “comprising” when used in this specification, specify the presence of stated features, steps, operations, elements and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in the commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The present disclosure is to be considered as an exemplification of the invention, and is not intended to limit the invention to the specific embodiments illustrated by the figures or description below.

This invention includes hardware, software and procedure.

Hardware includes a camera system that can focus into a small section of the water jet; optical filtration components that can filter out light wavelength emitting from machining plasma and other unrelated resources, but only keep a small bandwidth surrounding the wavelength of the original laser beam confined in the water jet; optical attenuation components that will attenuate the brightness of the glowing water jet, improve the signal to noise ratio for digital analysis system; light sensing system that can assign brightness level to each pixel indicated on the digital panel or screen, for example, we can calibrate the darkest spot sensed as 0 and brightest spot sensed as 255; A computer system that can take program and set up from operator;

Digital analysis system includes an image recognition program that can see the laser jet; a program that will allow operator to input threshold of bright level; a analysis program that tell each pixel into bright or dark, based on the bright level threshold; a software that will record bright or dark pixels in the image and measure the width of the laser jet; a program that can compare the measured width of laser jet to previous measurement and stored data, then conclude the result and communicate to machine controller 12.

Procedure is defined as:
Step 1~Install a new set of optical—water jet coupling components, turn on the laser power. After machine operation is stabilized, turn on the camera system and digital analysis system, record the virgin width of laser jet for the new coupling components.
Step 2~Before the start of each operation after the set up described in Step 1, measure the laser jet width and compare it with the virgin width. Usually, as coupling components degrade during operation, the laser jet width will get bigger. Based on experiments and experience, a preset width value is input in the digital analysis system, once the measured width is larger than preset width, machine will send message to operator for coupling components replacement.
Step 3~During the drilling operation, camera is focusing at the same spot where the virgin width and starting width are measured. The spot picked for camera focus should be at least 5 mm above the part surface, in order to avoid the very strong plasma light from laser—material interaction. The water jet pressure usually lies between 100-400 bar, the standoff distance between laser head and part surface is between 10 mm to 50 mm. The reflected water stream can reach more than 100 mm. Therefore, the whole length of water jet between laser head to part surface is exposed under the interference of reflected water stream.
Step 4~Before the part body has been broken through by the laser power, there is a strong reflected water stream goes up against the incoming water jet and shielding gas. The stability of laminar water jet is reduced, more laser power is lost by scattering out of water jet. The measured laser jet width is bigger than virgin width and starting width. A preset value can be added to digital analysis system as the threshold, as long as the measured width of laser jet is greater than this threshold, we can tell there is still a significant of reflected water stream, and the hole is not drilled through.
Step 5~At the moment the laser water jet break through the part body, incoming water jet will have a passage to exit to the back side of the body instead of reflect back. As result, the amount of water stream get reflected backward against incoming water jet is significantly reduced, i.e., only happens when water jet hits the edge of the drilled through feature. The measured laser jet width, will drop under the preset threshold width. Once digital analysis sensed this drop, it will conclude a break through and trigger next motion in the program.

TABLE 1
sample of a preset table for coupling components health monitor

| | | Health State |
|---|---|---|
| | | Optical-Water Jet Coupling |
| Virgin laser jet width | Idling laser jet width | Components |
| 60 um | 60 um | 100% |
| 60 um | 70 um | 90% |
| 60 um | 80 um | 50% |
| 60 um | . . . | |
| 60 um | 120 um | Need replacement |

TABLE 2
sample of a preset table for machining progress monitor

| Pre-start | Machining | Health State Optical-Water Jet Coupling |
|---|---|---|
| laser jet width | laser jet width | Components |
| 70 um | 100 um | penetration depth < 10% |
| 70 um | 95 um | penetration depth < 20% |
| 70 um | 90 um | penetration depth < 30% |
| 70 um | . . . | . . . |
| 70 um | 72 um | Full penetration achieved-break through |

1. A digital-optical analysis system that can focus onto a very thin water jet (30 um to 200 um) and clearly image the glowing water jet when laser beam is transferred inside the water jet. The system will include a wavelength filter, optical attenuator, camera and sensor, program to analyze the brightness of each pixel and software to interpret the pixel and communicate to the machine controller.

2. A procedure that measure the idling laser jet width and compare it to laser jet width with brand new optical water jet coupling components. The difference between two values is compared to a preset table 1 and the health status of the coupling components can be determined.

3. A procedure that measured laser jet width during machining process and compare it to laser jet width before machining start. The difference between two values are compared against a preset table 2 and the progress state of the drilling can be determined.

4. Preset table samples given in Table 1 and Table 2 are just examples showing the theory, different applications and optical components set up will have different preset table based on experiments and analysis.
